(19) United States
(12) Patent Application Publication
(10) Pub. No.: US 2012/0264382 A1
(43) Pub. Date: Oct. 18, 2012

(54) SYSTEM AND METHOD FOR DEVICE BEHAVIOR MODIFICATION BASED ON EXTERNAL ANTENNA DETECTION INSIDE RESTRICTED AREAS

(75) Inventor: Ian Lockerbie, Calgary (CA)

(73) Assignee: Novatel Wireless, Inc., San Diego, CA (US)

(21) Appl. No.: 13/086,617

(22) Filed: Apr. 14, 2011

(51) Int. Cl. H04B 7/00

(52) U.S. Cl. 455/90.2

(57) ABSTRACT

A device behavior modification apparatus is provided to detect insertion of an external antenna into a portable communication device, and identify the external antenna as being either, e.g., a valid, FCC-approved external antenna or an invalid external antenna. The apparatus may determine whether or not an internal antenna is being utilized and/or has been substituted with the inserted external antenna. Depending on the type of external antenna inserted, the apparatus may react and effectuate changes to the operation of the portable communication device and/or the external antenna. Such behavior modification may include, e.g., reducing the RF signal power output or disabling the radio portion of the portable communication device altogether. Additionally, the apparatus may receive certain augmentative information to notify the apparatus or allow the apparatus to determine the region within which it is operating.

### FIELD OF THE INVENTION

The present invention relates generally to portable communication devices, and more particularly, to systems and methods for detecting the use of an external antenna, and modifying the operation of the external antenna and/or portable communication devices to remain in compliance with regulatory restrictions.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Federal Communications Commission (FCC) has recently promulgated changes to rules regarding the regulation of external antenna use in portable communication devices. In particular, the FCC has expressed growing concern about external antennas and their Specific Absorption Rate (SAR) effects. The FCC previously adopted limits for safe exposure to radiofrequency (RF) energy given in terms of SAR units, a measure of the amount of RF energy absorbed by the body when using a device, such as a mobile phone. For example, the FCC requires mobile phone manufacturers to ensure that their phones comply with these objective limits for safe exposure by operating at or below the desired SAR levels. The FCC has also set forth rules concerning SAR levels of devices that may utilize external antennas, such as Universal Serial Bus (USB) dongles, external and/or embedded modems, etc.

These new changes may require that only approved antennas be used with modem products while operating within the U.S. However, such a requirement conflicts with the needs/desires of other regions/countries/carriers, e.g., Europe, that do favor the inclusion of external antenna connectors on portable/mobile communication devices so that external antennas may be used. Additionally still, certain communication devices presently have the ability to roam both inside and outside the U.S. For products than can be utilized in regions with conflicting regulations regarding the use of external antennas, problems arise when attempting to satisfy such outside-U.S. consumer demands with the aforementioned FCC regulation changes.

Hence, without mechanisms for addressing these regulatory conflicts, manufacturers and/or service operators may be forced to make or sell only those portable communication devices that do not provide an external antenna port. Moreover, conventional products may fail FCC approval pursuant to the recent rule changes. It would therefore be advantageous to allow for the disabling of unapproved external antennas when portable communication devices are operating within regions under the FCC's purview. Such a feature would allow manufacturers and/or service providers to satisfy both the FCC requirements within the U.S., as well as external antenna needs/demands when operating in regions outside the FCC's control.

### SUMMARY OF THE INVENTION

One embodiment of the present invention relates to an apparatus for modifying the behavior of a device, where the apparatus comprises a hardware module and a software module. The hardware module is configured to detect insertion of an external antenna into a device. The hardware module is also configured to identify the external antenna. Upon becoming aware of the external antenna being present in the device, the software module is configured to modify a behavior of the device based upon at least the identity of the external antenna. Detection of the insertion of an external antenna may be achieved by determining an electrical or physical presence of the external antenna, and identification of the external antenna involves determining whether the external antenna is valid or invalid.

Another embodiment of the present invention relates to a method for modifying the behavior of a device. The method comprises detecting insertion of an external antenna into a device and identifying the external antenna as either a valid antenna or an invalid antenna. The method further comprises modifying a behavior of the device based upon at least the identity of the external antenna upon becoming aware of the external antenna being present in the device. If the external antenna is identified to be invalid, the transmit power of the device is reduced or alternatively, it is disabled. Moreover, information may be received identifying a region within which the device is operating, and modifying the behavior of the device based upon a determination that the region in which the device is operating comprises an external-antenna-regulated region.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of an exemplary system in accordance with various embodiments of the present invention;

FIG. 2 is an exemplary schematic representation of the components of a portable communication device with which various embodiments of the present invention may be utilized;

FIG. 3 is a flow chart of an exemplary method for modifying the behavior of a portable communication device in accordance with various embodiments of the present invention; and

FIG. 4 is an exemplary external antenna detection and identification circuit diagram in accordance with various embodiments of the present invention.

### DETAILED DESCRIPTION OF THE PREFERRED EMBODIMENTS

Portable communication devices commonly transmit RF signals through an antenna. Such communication devices may be used in a variety of manners and in a variety of conditions. As alluded to above, exposure to RF radiation from an RF signal source may be harmful to human tissue, and hence the FCC requires devices, such as USB dongles, to be tested to ensure that the SAR levels of such devices are within acceptable levels. For example, until recently, the FCC required devices to be tested at a separation of 1.5 cm between the device and a phantom simulating human body tissue. Recently, the FCC has required that the separation distance in such tests be reduced to 0.5 cm.

The SAR level is based on the power level of the RF signal source, such as the antenna of the device, and the proximity of the RF signal source to live tissue, such as human tissue. Greater power level and closer proximity result in greater SAR levels. Conversely, lower power level and increased distance result in lower SAR levels.

In accordance with various embodiments of the present invention and in response to the recent changes in FCC regulations, a hardware and software-based device behavior modification apparatus is provided which detects the insertion of an external antenna into a portable communication device. Once an external antenna is connected/inserted into the portable communication device, the apparatus may uniquely identify the external antenna to be of a certain antenna type. The antenna types may include an FCC-approved external antenna or a generic/invalid external antenna. Further still, the apparatus may be configured to determine whether or not an internal antenna is being utilized and/or has been substituted with the inserted external antenna.

Depending on the type of antenna inserted into a portable communication device or whether an internal antenna is being utilized, the apparatus may be configured to react and effectuate changes to the operation of the portable communication device and/or the external antenna. For example, upon identifying that a generic/invalid external antenna has been inserted into the portable communication device, the apparatus can modify the behavior of the external antenna and/or portable communication device to remain compliant with any applicable regulations. Such behavior modification may include, e.g., reducing the RF signal power output or disabling the radio portion of the portable communication device altogether.

To properly modify the behavior of the external antenna and/or portable communication device, the apparatus may receive certain augmentative information to notify the apparatus or allow the apparatus to determine the region within which it is operating. This augmentative information may include, but is not limited to, network carrier identification information, network country information, and/or other location-identifying information, such as Global Positioning System (GPS), Assisted GPS (AGPS), Cell ID, triangulation, or Mobile Switching Center Identification (MSC ID) information.

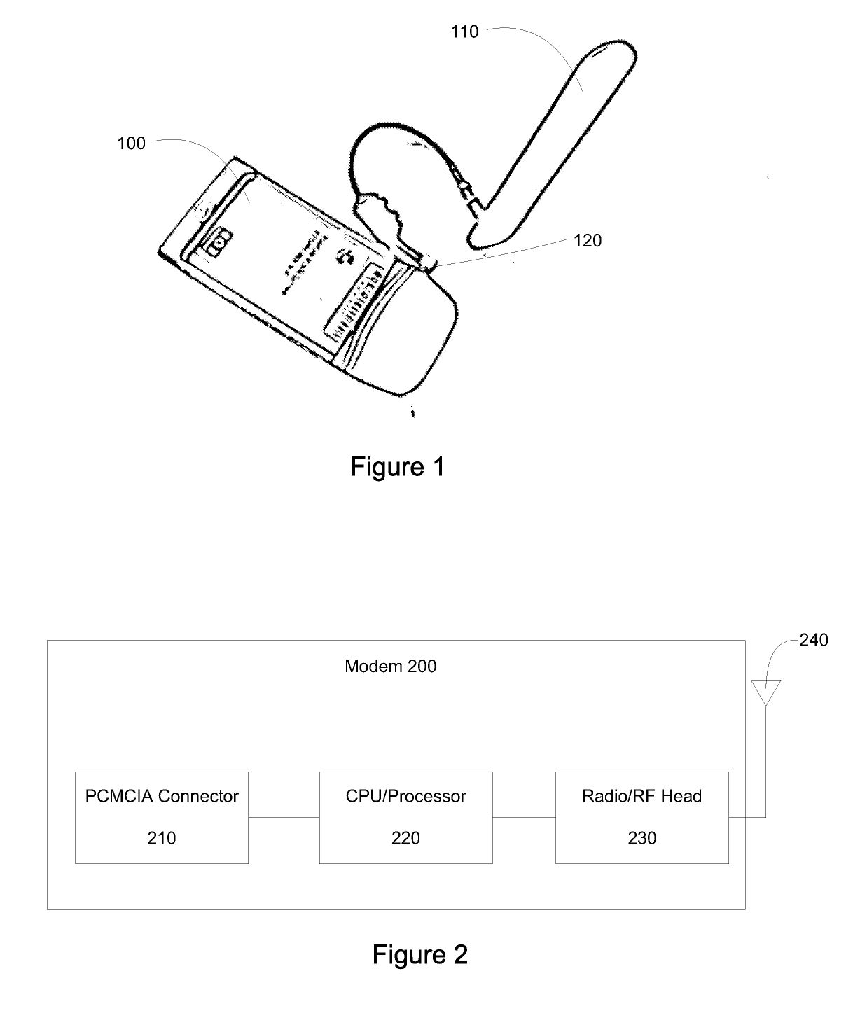

FIG. 1 is a representation of an exemplary system in accordance with various embodiments of the present invention. The exemplary system includes, for example, a portable communication device 100 with or within which various embodiments of the present invention may be implemented. In this example, the communication device 100 may be an Express Card/Personal Computer Memory Card International Association (PCMCIA) card-based modem. Additionally, the exemplary system includes an external antenna 110 that may be connected to/inserted into the communication device 100 via a connection point 120. It should be noted that the communications device 100 is not necessarily limited to an Express Card/PCMCIA card-based modem and may be a USB dongle, as discussed above, or other portable communication device to which an external antenna may be attached. Moreover, it should be noted that the aforementioned apparatus for modifying the behavior of the external antenna and/or portable communication device may be implemented as part of the portable communication device 100 via a combination of hardware and software as will be discussed in greater detail below.

Current wireless RF modems that cooperatively operate with a host computing device typically include: (1) a radio portion, also called an RF front end or an RF head; (2) a modulator/demodulator portion, also called a baseband processing unit or baseband chip; (3) a central processing unit (“CPU”) or processor; (4) memory; and (5) an interface. These modem components collectively operate during a wireless communications process to receive an electromagnetic RF signal in a receive mode, wherein the RF signal contains information to be extracted from the received RF signal, and in a transmit mode, wherein, the components work collectively to transmit an electromagnetic RF signal and the RF signal contains the information to be transmitted. Moreover, during the receive and transmit modes, the modem components collectively operate to perform three principal modem functions: RF conversion, baseband processing and protocol stack control.

Typically during RF conversion, the RF head receives the RF signal during the receive mode and converts that RF signal into a modulated baseband analog signal and, during the transmit mode, the RF head converts a modulated baseband analog signal into an RF signal for transmission. During baseband processing, the baseband processing unit in the receive mode demodulates the modulated baseband analog signal by extracting a plurality of data bits that correspond to the information being received. In the transmit mode, the baseband processing unit generates the modulated baseband analog signal for processing by the RF head.

FIG. 2 illustrates a simplified, exemplary schematic representation of the components of a communication device, such as the modem 100 of FIG. 1. FIG. 2 illustrates a modem 200 that comprises at least a PCMCIA Connector 210 for connecting the modem 200 to a host computing device, such as a laptop computer. In turn the PCMCIA Connector 210 is connected to a central processing unit (CPU)/Processor 220, that in accordance with various embodiments of the present invention, may control operation of the radio portion/RF Head 230 to, e.g., reduce the power ultimately transmitted through an external antenna 240 or disable the radio portion/RF Head 230 completely as discussed above. It should be noted that the modem 200 may utilize an internal antenna (not shown) as well as the external antenna 240 depending on the manner in which the modem 200 is configured and/or manufactured.

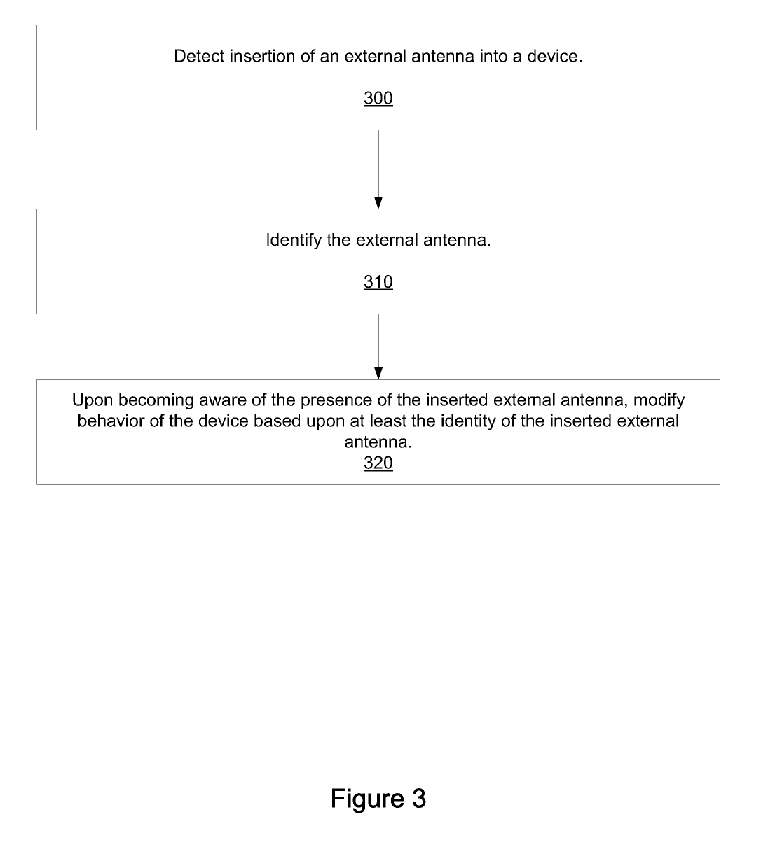

FIG. 3 is an exemplary flow chart of processes performed in accordance with various embodiments of the present invention for modifying the behavior of an external antenna and/or portable communication device. At 300, insertion of an external antenna into a device is detected. A hardware detection and identification module (described in greater detail below) may be utilized to detect the insertion of the external antenna. At 310, the inserted external antenna is identified by the hardware detection and identification module. At 320, software or a software behavior modification module is utilized to monitor the portable communication device for the insertion of an external antenna, i.e., the software/software module becomes aware of the external antenna upon detection. The software/software behavior modification module may be implemented as part of or within the portable communication device, such as the modem 200 illustrated in FIG. 2. For example, the monitoring software may be implemented as part of the CPU/Processor 200. Upon becoming aware of the insertion of the external antenna, the software/software behavior modification module modifies the behavior of the device based upon at least the identity of the inserted external antenna.

Different methods of detecting the insertion of an external antenna and identifying the external antenna may be utilized by the hardware detection and identification module. In accordance with one aspect of the present invention, the hardware module may rely on detection via the electrical presence of the external antenna. For example, and as alluded to above, an external antenna may be used as a substitute for a portable communication device's internal antenna. To effectuate such a substitution, the internal antenna is electrically disconnected from, e.g., a modem, upon the external antenna being connected. This disconnection may be leveraged by the hardware module, whereby the disconnection is detected by biasing the modem side of an antenna switch, while designing in a pull-down resistor on the internal antenna side of the antenna switch.

An antenna switch may be utilized to allow the same antenna to be used for both reception and transmission in the modem. Pull-down resistors are generally connected to ground and hold a logic signal near zero volts when no other active device is connected, and are used in electronic circuits to ensure that inputs settle at expected logic levels if external devices are disconnected. That is, a pull-down resistor weakly “pulls” the voltage of the wire it is connected to towards its voltage source level when other components on the line are inactive. When all other connections on the line are inactive, they are high-impedance and act like they are disconnected. Since the other components act as though they are disconnected, the circuit acts as though it is disconnected, and the pull-down resistor brings the wire up to a high logic level. When another component on the line goes active, it will override the high logic level set by the pull-down resistor.

With regard to identification of an external antenna, such external antennas can be designed to have an “ID” such that the external antenna can be detected by a portable communication device, such as a modem, upon the external antenna being inserted therein. A pull-down resistor may again be utilized, where the pull-down resistor utilized may have a predetermined value that is considered to be “valid.” Therefore and upon insertion, a portable communication device will be able to identify an external antenna as being either valid or invalid. It should be noted that the configuration of the pull-down resistor predetermined value would be dependent upon that external antenna being deemed valid by, e.g., the FCC.

For example, if a valid external antenna were identified by the hardware detection and identification module, its use by the portable communication device would be allowed. If, for example, an external antenna was determined to be a generic or invalid antenna, its continued use would depend on where the portable communication was operating. If operation was occurring in a region with no external antenna regulations, the generic or invalid antenna could still be used. However and if operation was occurring in a region with external antenna regulations, the portable communication device would have to adjust its behavior to comply with the relevant restrictions (such as the aforementioned SAR rules) for that region.

Detection of an external antenna may also be accomplished by virtue of an external antenna's physical presence. That is, the majority of external antenna jacks are metal. Thus, when a metal external antenna jack is inserted into an antenna port, a sense pin may be utilized to detect the presence of that metal. Alternatively, the capacitance created by the presence of the external antenna jack could also be leveraged as a way to detect the physical presence of an external antenna.

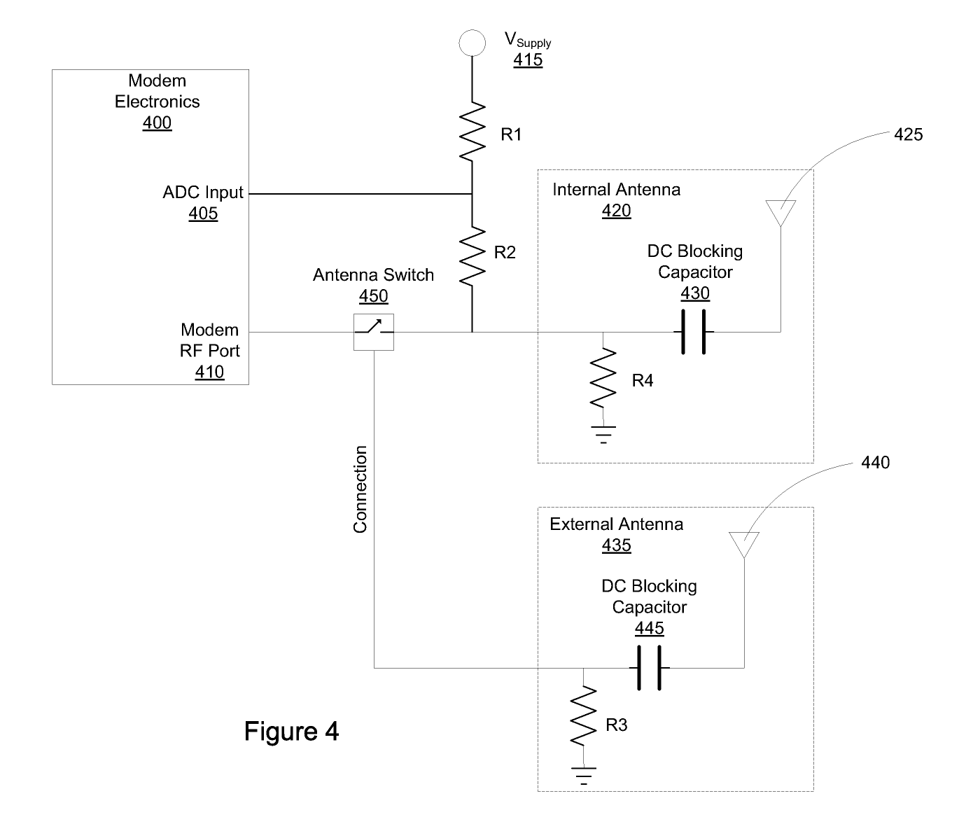

FIG. 4 is an exemplary circuit diagram of the hardware detection and identification circuit configured in accordance with various embodiments of the present invention. Modem electronics 400 are illustrated in FIG. 4 to comprise at least an analog-digital converter (ADC) input 405 and a modem RF port 410. The aforementioned biasing can be achieved using a voltage divider formed using resistors R1 and R2 with an input voltage V_{Supply} 415. As described above, an internal antenna 420 may be initially utilized, where the internal antenna 420 includes a physical antenna 425, a DC blocking capacitor 430, and pull-down resistor/ID R4. When the internal antenna 420 is utilized, the Vadc voltage is equivalent to the following:

$$Vadc = \frac{( {R}_{2} + {R}_{4} )}{( {R}_{1} + {R}_{2} + {R}_{4} )}$$

External antenna 435 may include a physical antenna 440, its own DC blocking capacitor 445, and pull-down/ID resistor R3. As also described above, the external antenna 435 may be connected to the portable communication device, in this case to the modem RF port 410 via an antenna switch 450, disconnecting the internal antenna 420. When the external antenna 435 is utilized, and the external antenna is a valid one, the Vadc voltage is equivalent to the following:

$$Vadc = \frac{( {R}_{2} + {R}_{4} )}{( {R}_{1} + {R}_{2} + {R}_{4} )}$$

The external antenna 435 would be determined to be an invalid antenna if the Vadc is either greater or less than either of the above voltages.

Once the software/software behavior modification module of the device behavior modification apparatus becomes aware of the presence of an external antenna, it may modify the behavior of the portable communication device. As described above, such modification may entail reducing the output power of the radio portion/RF head of the portable communication device, or alternatively disabling the portable communication device entirely.

Whether the software/software behavior modification module does modify the behavior of the portable communication device may be determined based on certain “restriction” criteria being met, i.e., whether the portable communication device is operating in a region with restrictions on the use of external antennas, such as the U.S. To determine whether the portable communication device is operating in such a region, the radio network country code of restricted regions may be compared to that within which the portable communication device is currently operating. If the radio network country code within which the portable communication device matches that of a restricted region, the portable communication device behavior is modified accordingly. Internet Protocol (IP) address information, website information, or other network identifying information may also be used to determine whether the portable communication device is operating in a restricted region. Further still, the radio operating band or technology utilized by the portable communication device may be checked to determine if either is an operating band or technology utilized in a restricted region. Moreover, and as indicated above, location-based information such as GPS, WiFi Service Set Identifiers (SSIDs), or any other type of location or network carrier identifying information may be utilized to determine whether the portable communication device is operating within a restricted region.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. An apparatus, comprising:
a hardware module configured to:
detect insertion of an external antenna into a device; and
identify the external antenna; and
a software module configured to, upon becoming aware of the external antenna being present in the device, modify a behavior of the device based upon at least the identity of the external antenna.

2. The apparatus of claim 1, wherein the hardware module is further configured to detect the insertion of the external antenna via an electrical presence of the external antenna.

3. The apparatus of claim 2, wherein the external antenna is utilized as a substitute for an internal antenna of the device, and wherein the electrical presence of the external antenna is signified by electrical disconnection of the internal antenna upon substitution by the external antenna.

4. The apparatus of claim 3, wherein the electrical disconnection of the internal antenna is detectable via a biasing of a modem side of an antenna switch and presence of a pull-down resistor on an internal antenna side of the antenna switch.

5. The apparatus of claim 1, wherein the hardware module is further configured to identify the external antenna as one of a valid external antenna and an invalid external antenna.

6. The apparatus of claim 5, wherein the valid external antenna comprises a Federal Communications Commission (FCC) pre-approved external antenna.

7. The apparatus of claim 6, wherein the hardware module is further configured to identify the external antenna via detection of a predetermined value associated with a pull-down resistor electrically connected to the external antenna.

8. The apparatus of claim 1, wherein the hardware module is further configured to detect the insertion of the external antenna via a physical presence of the external antenna.

9. The apparatus of claim 1, wherein the physical presence of the external antenna is signified by a particular capacitance detected by a sense pin upon the insertion of the external antenna.

10. The apparatus of claim 9, wherein detection of the particular capacitance results from the external antenna comprising, in part, a metallic external antenna jack.

11. The apparatus of claim 1, wherein the software module is configured to allow continuing utilization of the external antenna upon the external antenna being identified to be valid.

12. The apparatus of claim 1, wherein the software module is configured to modify the behavior of the device based upon a determination that the identity of the external antenna is that of an invalid external antenna.

13. The apparatus of claim 12, wherein upon the identification of the external antenna as being invalid, the software module is further configured to reduce transmit power of the device.

14. The apparatus of claim 12, wherein upon the identification of the external antenna as being invalid, the software module is further configured to disable operation of the device.

15. The apparatus of claim 12, wherein the software module is further configured to receive information identifying a region within which the device is operating, and wherein the software module is further configured to modify the behavior of the device based upon a determination that the region within which the device is operating comprises an external-antenna-regulated region.

16. The apparatus of claim 15, wherein the received information comprises at least one of a radio network country code, network identifying information, radio operating band information, radio technology information, network carrier identifying information, and location-based information.

17. A method, comprising:
detecting insertion of an external antenna into a device;
identifying the external antenna; and
modifying a behavior of the device based upon at least the identity of the external antenna upon becoming aware of the external antenna being present in the device.

18. The method of claim 17, wherein the detecting of the insertion of the external antenna comprises detecting an electrical presence of the external antenna, and wherein the electrical presence of the external antenna is signified by electrical disconnection of an internal antenna upon substitution by the external antenna.

19. The method of claim 17, wherein the identifying of the external antenna comprises identifying the external antenna as one of a valid external antenna and an invalid external antenna.

20. The method of claim 17, wherein the detecting of the insertion of the external antenna comprises detecting a physical presence of the external antenna.

21. The method of claim 17 further comprising, allowing continued utilization of the external antenna upon the external antenna being identified to be valid.

22. The method of claim 17, wherein the modification of the behavior of the device is based upon a determination that the identity of the external antenna is that of an invalid external antenna.

23. The method of claim 22, wherein upon the identification of the external antenna as being invalid, the software module is further configured to reduce transmit power of the device.

24. The method of claim 22 further comprising, disabling operation of the device upon the identification of the external antenna as being invalid.

25. The method of claim 22 further comprising, receiving information identifying a region within which the device is operating, and modifying the behavior of the device based upon a determination that the region in which the device is operating comprises an external-antenna-regulated region.
